(19) United States
(12) Patent Application Publication
(10) Pub. No.: US 2010/0109437 A1
(43) Pub. Date: May 6, 2010

(54) Battery pack disconnection method for a hybrid vehicle

(76) Inventor: Gerald T. Fattic, Fishers, IN (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/290,974

(22) Filed: Nov. 5, 2008

(51) Int. Cl. H02J 1/16

(52) U.S. Cl. 307/47; 903/903

(57) ABSTRACT

A control methodology for an engine-driven electric machine of a hybrid vehicle electrical system for enabling continued operation of the vehicle electrical system under failure mode conditions that require disconnection of the battery pack from the electrical system. At the onset of a failure mode condition requiring disconnection of the battery pack, the electric machine is operated as a generator and controlled in accordance with a first mode of operation such that its output substantially matches the instant electrical load requirements of the vehicle without supplying charging current to the battery pack. When the battery pack current falls below a near-zero threshold, a relay is activated to disconnect the battery pack from the electrical system, and the electric machine is then controlled in accordance with a second mode of operation for maintaining the operating voltage of the electrical system at a specified value.

### TECHNICAL FIELD

The present invention is directed to a failure-mode battery disconnect method for a hybrid vehicle electrical system including a high voltage battery pack and an engine-driven electric machine operable in generating and motoring modes, and more particularly to a control method for taking the battery pack off-line while permitting continued operation of the engine and electric machine.

### BACKGROUND OF THE INVENTION

The fuel efficiency of a motor vehicle can be considerably enhanced with a hybrid system including an electric machine coupled to the engine, a high voltage battery pack, and a power electronics system for interconnecting the electric machine, the battery pack and the electrical loads of the vehicle. The electric machine is operable in a generating mode to charge the battery pack and supply power to various electrical loads, and in a motoring mode to crank the engine and to augment the engine power output. Various drive arrangements can be used to propel the vehicle. For example, the engine can be coupled to the drive wheels through a conventional drivetrain, and/or one or more electric propulsion motors can be used.

FIG. 1 illustrates an example of a hybrid vehicle system including an engine 10 that is mechanically coupled to a set of drive wheels 12 through a transmission (T) 14 and differential gearset (DG) 16. The hybrid vehicle system includes an AC electric machine 18, a main 120-volt battery pack 20, and a power conversion system 22. The electric machine 18 is selectively operable in generating and motoring modes, and is mechanically coupled to the engine 10, either directly or by way of a drive belt. The power conversion system 22 includes a high voltage DC bus 24, a bus capacitor 26 for maintaining the bus voltage, a relay 28 coupling the positive side of high voltage bus 24 to the battery pack 20, an inverter 30 coupling high voltage bus 24 to the electric machine 18, a DC-to-DC converter 32 coupling high voltage bus 24 to a low voltage DC bus 34, and a Power Control Unit (PCU) 36 for controlling the operation of relay 28, inverter 30 and DC-to-DC converter 32. The low voltage DC bus 34 is used to supply power to various 12-volt electrical loads 38 of the vehicle, and an auxiliary 12-volt storage battery 40 is coupled to the low voltage bus 34 for maintaining the bus voltage and temporarily supplying power to the loads 38 in the event of a system failure.

Under certain failure mode conditions such as battery pack over-temperature, it is necessary to disconnect battery pack 20 from the high voltage bus 24. The relay 28 serves as the disconnect device, but first the PCU 36 powers down the inverter 30 and DC-to-DC converter 32 to minimize the current that the relay 28 must break, and to prevent load-dump transient voltages. However, once the battery pack 20 is off-line, there is insufficient reserve electrical power to re-activate the electric machine 18 and the only source of power for the electrical loads 38 is the auxiliary storage battery 40. Unfortunately, this significantly limits the failure-mode range of the vehicle because certain electrical loads such as the engine ignition system are required for continued operation of engine 10. Accordingly, what is needed is a way of disconnecting the battery pack 20 from the high voltage bus 24 without having to forego the generating capability of the electric machine 18.

### SUMMARY OF THE INVENTION

The present invention is directed to an improved control methodology for an engine-driven electric machine of a hybrid vehicle electrical system for enabling continued operation of the vehicle electrical system under failure mode conditions that require disconnection of the battery pack from the electrical system. At the onset of a failure mode condition requiring disconnection of the battery pack, the electric machine is operated as a generator and controlled in accordance with a first mode of operation such that its output substantially matches the instant electrical load requirements of the vehicle without supplying charging current to the battery pack. When the battery pack current falls below a near-zero threshold, a relay is activated to disconnect the battery pack from the electrical system, and the electric machine is then controlled in accordance with a second mode of operation for maintaining the operating voltage of the electrical system at a specified value. In each mode of operation, the control is dynamically compensated for changes in the speed and efficiency of the electric machine and changes in the electrical load requirements of the vehicle.

### BRIEF DESCRIPTION OF THE DRAWINGS

FIG. 1 is a block diagram of an exemplary hybrid vehicle electrical system and powertrain, including an engine, a high voltage battery pack, an engine-driven electric machine operable in generating and motoring modes, and a microprocessor-based Power Control Unit; and

FIG. 2 is flow diagram representing a control methodology according to this invention that is implemented by the microprocessor-based Power Control Unit of FIG. 1 under failure mode conditions requiring disconnection of the battery pack.

### DESCRIPTION OF THE PREFERRED EMBODIMENT

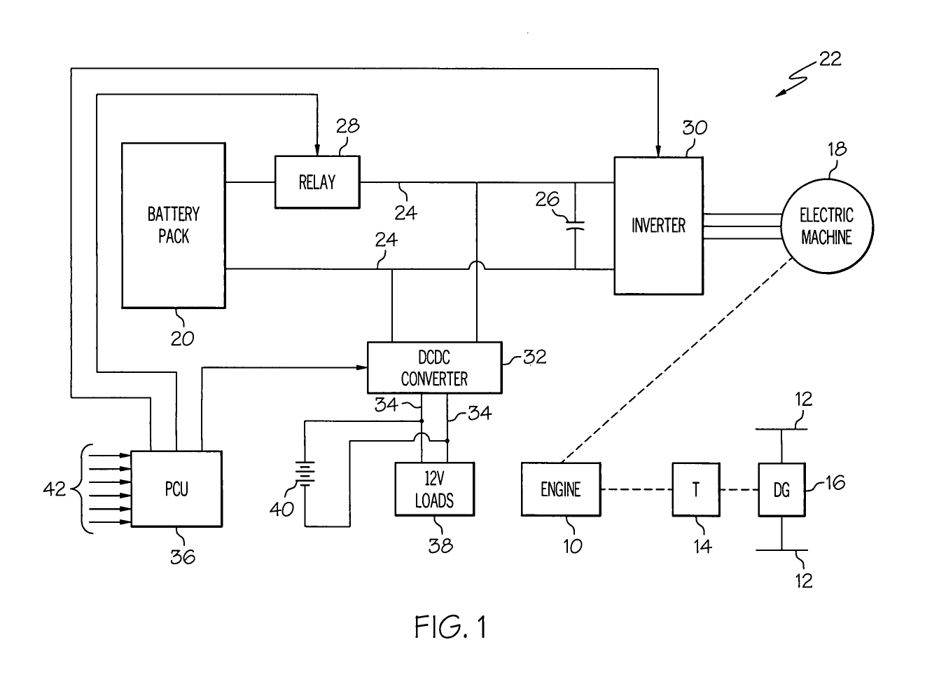

While the method of the present invention is disclosed herein in the context of the exemplary hybrid vehicle electrical system and powertrain of FIG. 1, it should be understood that the described method is applicable to any hybrid vehicle electrical system including a battery pack and an engine-driven electric machine. Virtually all hybrid vehicle electrical systems include a battery pack for storing electrical energy and an engine-driven electric machine selectively operable in a generating mode to charge the battery pack and supply power to various electrical loads, and in a motoring mode to crank the engine and to augment the engine power output. And in all such configurations, there is the possibility of a failure mode condition that requires disconnection of the battery pack from the vehicle electrical system—for example, from the high voltage bus 24 in the configuration of FIG. 1. But the disconnect relay 28 (or comparable disconnect device) cannot safely or reliably interrupt the connection if the battery pack current is too high, and even in cases where the connection can be interrupted, the interruption can cause load-dump transient voltages severe enough to damage electronic components coupled to the high voltage bus 24. The conventional approach of powering down the inverter 30 and DC-to-DC converter 32 to minimize the battery pack current so that the battery pack 20 can be reliably disconnected results in the undesired situation in which there is insufficient reserve electrical power to re-activate the electric machine 18. And with the auxiliary storage battery 40 as the only source of power for the electrical loads 38, the vehicle range will be substantially curtailed, particularly in hybrid configurations that utilize electric propulsion motors. In contrast, the method of the present invention minimizes the battery pack current by controlling the electric machine 18 so that its output substantially matches the instant electrical load requirements of the vehicle without supplying charging current to the battery pack 20. And once the battery pack 20 is safely disconnected, the electric machine 18 is controlled in a manner to dynamically maintain the operating voltage of the electrical system at a specified value to enable continued normal operation of the vehicle until the engine 10 is turned off.

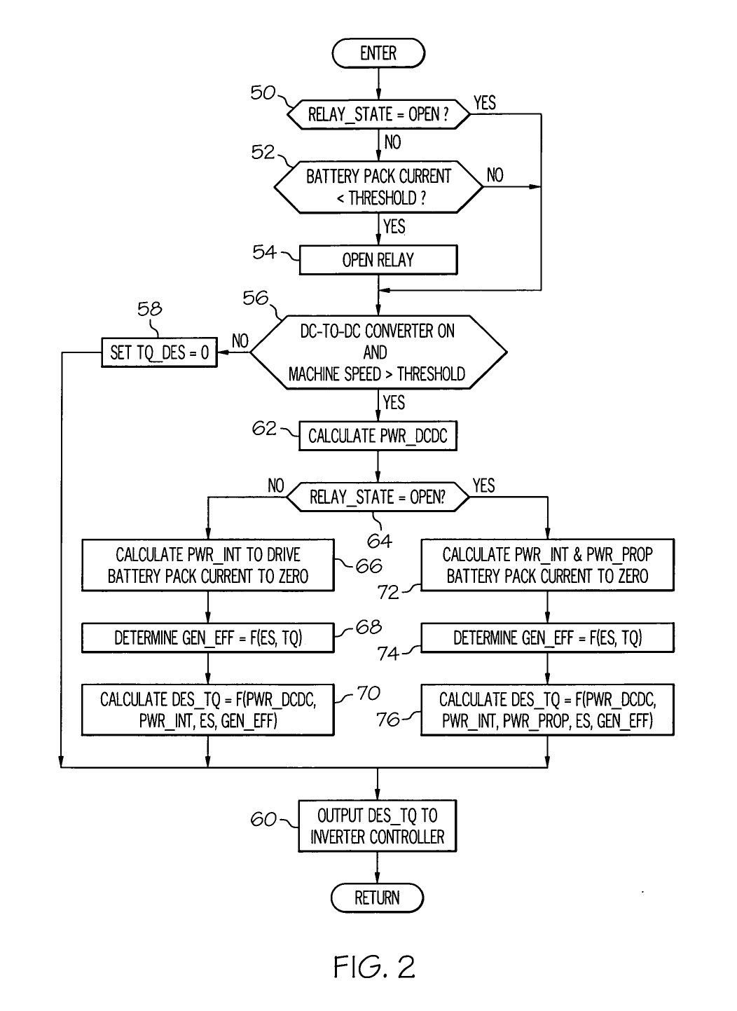

The flow diagram of FIG. 2 outlines the control method of the present invention, and as such, describes a software routine periodically executed by the PCU 36 of FIG. 1 in response to detection of a failure mode requiring disconnection of the battery pack 20. The disclosed control assumes that the inverter 30 includes a controller configured to accept a desired torque input and control the machine winding currents accordingly. In the motoring mode, the desired torque input indicates the desired torque output of the machine 18; and in the generating mode, the desired torque input indicates a load torque that is supplied to the machine 18 by engine 10 for producing electric power.

Referring to FIG. 1, the PCU 36 receives inputs 42 pertaining to a number of system-related parameters pertaining to the method of the present invention, including the battery pack current I_BP, the voltage HV_BUS of high voltage bus 24, the engine speed ES, the DC-to-DC converter input current I_DCDC, and the state RELAY_STATE of relay 28. And for purposes of this invention, the PCU 36 outputs the desired machine mode (i.e., generating or motoring) and the desired torque DES_TQ to the inverter 30.

In general, the desired torque output DES_TQ is iteratively calculated both before and after disconnection of the battery pack 20 as follows:

DES_{—}TQ=(PWR_{—}DCDC+PWR_{—}CNTL)/(ES*GEN_{—}EFF) (1)

where PWR_DCDC is the input power of DC-to-DC converter 32, PWR_CNTL is a power control term, and GEN_EFF is the generating efficiency of the electric machine 18. The converter input power POWER_DCDC is computed according to the product of the bus voltage HV_BUS and the converter input current I_DCDC. The generating efficiency GEN_EFF of the electric machine 18 can be determined by table look-up as a function of its rotational speed (which is proportional to, or equal to, engine speed ES depending on the powertrain configuration) and the desired torque output DES_TQ.

The power control term PWR_CNTL in equation (1) is formulated so that the desired torque output DES_TQ will satisfy the mode-specific control objective in addition to satisfying the low voltage load requirement. In the operating mode prior to battery pack disconnection, the control objective is to drive the battery pack current to zero. While in theory, this can be achieved by exactly matching the output of electric machine 18 with the current electrical load requirements, the power control term PWR_CNTL is formulated as an integrator term PWR_INT for driving the battery pack current I_BP to zero. Preferably, the integrator term PWR_INT for this operating mode is formulated as follows:

PWR_{—}INT=PWR_{—}INT_LAST−(INT_GAIN*LOOP_TIME*HV_BUS*I_{—}BP) (2)

where PWR_INT_LAST is the previous value of PWR_INT, INT_GAIN is a calibrated integrator gain term, and LOOP_TIME is the program loop time for updating PWR_INT.

Once the battery pack current I_BP falls within a calibrated current window, the relay 28 is activated to disconnect battery pack 20 from the high voltage bus 24, and the control objective for electric machine 18 then becomes maintaining the voltage on high voltage bus 24 at a desired value HV_BUS_DES. This is achieved by formulating the power control term PWR_CNTL of equation (1) as a proportional-plus-integral control. The proportional term PWR_PROP is preferably determined by table look-up as a function of the bus voltage error (HV_BUS−HV_BUS_DES). And the integral term PWR_INT in this case is formulated as follows:

PWR_{—}INT=PWR_{—}INT_LAST+(LOOP_TIME*INT_GAIN) (3)

where PWR_INT_LAST is the previous value of PWR_INT, LOOP_TIME is the program loop time for updating PWR_INT, and INT_GAIN is a integrator gain term preferably determined by table look-up as a function of the bus voltage error (HV_BUS−HV_BUS_DES).

Referring specifically to FIG. 2, the block 50 is first executed to determine whether relay 28 is open or closed, as indicated by the state of the RELAY_STATE flag. If the relay 28 is closed, the blocks 52 and 54 are executed to open relay 28 if the battery pack current I_BP is less than a specified current threshold. If the relay 28 is already open, the execution of blocks 52 and 54 is skipped. In either case, block 56 is then executed to determine if the entry conditions for the control are met. Specifically, the DC-to-DC converter 32 must be operating, and the engine 10 must be driving the electric machine 18. If one or both of these conditions are not met, blocks 58 and 60 set DES_TQ to zero, and output DES_TQ to inverter 30. However, if the conditions of block 56 are satisfied, block 62 computes the converter input power PWR_DCDC and block 64 determines whether relay 28 is open or closed. If the relay 28 is closed, blocks 60 and 66-70 are executed to define a first operating mode for which the control objective is to drive the battery pack current I_BP to zero. On the other hand, if the relay 28 is open, blocks 60 and 72-76 are executed to define a second operating mode for which the control objective is to maintain the voltage on high voltage bus 24 at the desired value HV_BUS_DES.

In the case where relay 28 is closed, the block 66 calculates the integrator term PWR_INT, block 68 determines the generator efficiency GEN_EFF, and block 70 calculates the desired torque output DES_TQ. The integrator term PWR_INT is calculated as a function of INT_GAIN, LOOP_TIME, HV_BUS, and I_BP according to equation (2) so that it continuously biases the battery pack current I_BP toward zero. The generator efficiency GEN_EFF is determined as a function of machine speed and torque, as mentioned above. And the desired torque output DES_TQ is calculated as a function of PWR_DCDC, PWR_CNTL, ES and GEN_EFF according to equation (1), where PWR_CNTL=PWR_INT.

In the case where relay 28 is open, the block 72 calculates the proportional and integral power terms PWR_PROP and PWR_INT, block 74 determines the generator efficiency GEN_EFF, and block 76 calculates the desired torque output DES_TQ. The proportional and integral power terms are both determined as a function of the bus voltage error (HV_BUS−HV_BUS_DES). As described above, the proportional power term PWR_PROP and the integrator gain term INT_GAIN are preferably determined by table look-up, and the integral power term PWR_INT is calculated according to equation (3). The combined effect of the proportional and integral power terms is to continuously drive the high bus voltage HV_BUS to the desired value HV_BUS_DES. As in the first control mode, the generator efficiency GEN_EFF is determined as a function of machine speed and torque. And the desired torque output DES_TQ is calculated as a function of PWR_DCDC, PWR_CNTL, ES and GEN_EFF according to equation (1), where PWR_CNTL=(PWR_PROP+PWR_INT).

In summary, the control methodology of the present invention present invention provides a safe and reliable way of disconnecting the battery pack 20 from the high voltage bus 24 without having to forego the generating capability of the electric machine 18, thereby avoiding a walk-home condition and maintaining normal operation of the engine 10 and other vehicle electrical loads 38 until the engine 10 is turned off. Regardless of whether the control objective is minimizing battery pack current or maintaining the high bus voltage, the controls are configured to dynamically compensate for changes in the speed and efficiency of the electric machine 18 as well as for changes in the electrical load requirements. While the control method has been described in reference to the illustrated embodiment, it should be understood that various modifications in addition to those mentioned above will occur to persons skilled in the art. Accordingly, it is intended that the invention not be limited to the disclosed embodiment, but that it have the full scope permitted by the language of the following claims.

1. A control methodology for a hybrid vehicle electrical system including one or more electrical loads, a high voltage battery pack and an engine-driven electric machine operable as a generator for charging said battery pack and supplying power to said electrical loads, the control methodology comprising the steps of:
initiating a failure mode control of said electric machine in response to detection of a failure mode requiring disconnection of said battery pack from said electrical system by controlling said electric machine according to a first control mode in which an output power generated by said electric machine satisfies a power requirement of said electrical loads without charging said battery pack;
disconnecting said battery pack from said electrical system when a prescribed battery pack current condition is met; and
controlling said electric machine according to a second control mode in which the output power generated by said electric machine satisfies a power requirement of said electrical loads while maintaining an operating voltage of said electrical system at a desired value.

2. The control methodology of claim 1, where controlling said electric machine according to said first control mode includes the steps of:
determining an input power requirement of said electrical loads and a battery pack current;
calculating a desired torque to be exerted by said electric machine as a function of the determined input power requirement and the determined battery pack current; and
controlling said electric machine to achieve said desired torque.

3. The control methodology of claim 2, where:
said desired torque is calculated as an integral function of the determined battery pack current.

4. The control methodology of claim 2, including the steps of:
determining a running speed of said electric machine; and
calculating said desired torque as an additional function of said running speed.

5. The control methodology of claim 2, including the steps of:
estimating a generating efficiency of said electric machine; and
calculating said desired torque as an additional function of the estimated generating efficiency.

6. The control methodology of claim 5, including the steps of:
determining a running speed of said electric machine; and
estimating the generating efficiency of said electric machine based on said running speed and said desired torque.

7. The control methodology of claim 1, where controlling said electric machine according to said second control mode includes the steps of:
determining an input power requirement of said electrical loads and a battery pack current;
measuring the operating voltage of said electrical system;
calculating a desired torque to be exerted by said electric machine as a function of the determined input power requirement and a deviation of the measured operating voltage from said desired value; and
controlling said electric machine to achieve said desired torque.

8. The control methodology of claim 7, where:
said desired torque is calculated as integral and proportional functions of the deviation of said measured operating voltage from said desired value.

9. The control methodology of claim 7, including the steps of:
determining a running speed of said electric machine; and
calculating said desired torque as an additional function of said running speed.

10. The control methodology of claim 7, including the steps of:
estimating a generating efficiency of said electric machine; and
calculating said desired torque as an additional function of the estimated generating efficiency.

11. The control methodology of claim 10, including the steps of:
determining a running speed of said electric machine; and
estimating the generating efficiency of said electric machine based on said running speed and said desired torque.
